(19) United States
(12) Patent Application Publication
(10) Pub. No.: US 2013/0140894 A1
(43) Pub. Date: Jun. 6, 2013

(54) DYNAMIC ENERGY-SAVING SOCKET

(71) Applicant: Whe-Ching LEE, New Taipei City (TW)

(72) Inventor: Whe-Ching LEE, New Taipei City (TW)

(21) Appl. No.: 13/447,940

(22) Filed: Apr. 16, 2012

(30) Foreign Application Priority Data
Dec. 2, 2011 (TW) 100144316

(51) Int. Cl. H02J 3/00

(52) U.S. Cl. 307/39

(57) ABSTRACT

The present invention relates to a dynamic energy-saving socket which comprises: a housing; a first socket; a sensor; a first relay; an active/passive sensing circuit; at least a second socket; a second relay; and a control unit. When a human is approaching the sensor, the first relay is enabled to be conducted for supplying electric source to the first socket, and when the loading value of the first socket exceeds a threshold value, the second relay is enabled to be conducted for supplying the electric source to the second socket, thereby achieving the objective of saving energy.

### BACKGROUND OF THE INVENTION

1. Field of the Invention

The present invention relates to a dynamic energy-saving socket, especially to a dynamic energy-saving socket capable of shutting off the electric source of an electric equipment being in a standby state and turning on the electric source while sensing a turning-on signal of the electric equipment for achieving an objective of saving energy.

2. Description of Related Art

A conventional electric equipment, e.g. a television, an audio system or an air conditioner, is often equipped with a remote controlling function, so a user can control the electric equipment by using a remote control. Generally, the electric equipment having remote controlling function is required to turn on the electric source for being in a standby state, so a control signal emitted by the remote control can be received at anytime. However, the electric equipment consumes the standby current while being in the standby state, the standby current is not high but still waste considerable amount of energy in long term because the electric source is turned on most of the time. Moreover, a conventional electric equipment is inserted with a socket for obtaining the electric source required for operation, the socket may be provided with function of surge absorbing or overcurrent protection, but not equipped with an energy-saving function.

### SUMMARY OF THE INVENTION

One primary objective of the present invention is to provide a dynamic energy-saving socket which comprises a first socket and at least a second socket, when a human is approaching a sensor, a first relay is enabled to be conducted for supplying electric source to the first socket, and when the loading value of the first socket exceeds a threshold value, a second relay is enabled to be conducted for supplying the electric source to the second socket, thereby achieving the objective of saving energy.

Another objective of the present invention is to provide a dynamic energy-saving socket, which is capable of determining whether the current of a socket exceeding a threshold value to decide supplying or not supplying electric power to a second socket of the dynamic energy-saving socket.

For achieving the objectives, the present invention provides a dynamic energy-saving socket, which comprises: a housing formed with at least a first orifice and at least a second orifice; a first socket installed in the housing and exposed outside the first orifice, and allowing an electric equipment to be inserted; a sensor installed in the housing or exposed outside the housing, and capable of sensing whether a human is approaching the first socket; a first relay installed in the housing and coupled to the first socket, one end thereof is coupled with an electric source, and capable of controlling whether supplying electric power to the first socket; an active/passive sensing circuit installed in the housing and coupled to the first socket, capable of sensing the loading value of the first socket; at least a second socket installed in the housing and each second socket is respectively exposed outside the second orifice for allowing another electric equipment to be inserted; a second relay installed in the housing and coupled to the second socket, one end thereof is coupled to the electric source, and capable of controlling whether supplying electric power to the second socket; and a control unit installed in the housing and respectively coupled to the sensor, the active/passive sensing circuit, the first relay and the second relay, when a human is approaching the sensor, a first control signal is outputted to the first relay, so the first relay is conducted for supplying the electric source to the first socket, and when the loading value of the first socket exceeds a threshold value, a second control signal is outputted to the second relay, so the second relay is conducted for supplying the electric source to the second socket, thus the electric source of the second socket is enabled to be terminated when the electric equipment is not turned on, thereby achieving the objective of saving energy.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view illustrating the assembly of the dynamic energy-saving socket according to one preferred embodiment of the present invention;

FIG. 2 is a block diagram illustrating the dynamic energy-saving socket according of the present invention;

FIG. 3 is a schematic view illustrating the assembly of the dynamic energy-saving socket according to another preferred embodiment of the present invention;

FIG. 4 is a schematic view illustrating the assembly of the dynamic energy-saving socket according to one another preferred embodiment of the present invention;

FIG. 5 is a schematic view illustrating the assembly of the dynamic energy-saving socket according to still one another preferred embodiment of the present invention;

FIG. 6 is a schematic view illustrating the assembly of the dynamic energy-saving socket according to still one another preferred embodiment of the present invention;

FIG. 7 is a schematic view illustrating the assembly of the dynamic energy-saving socket according to still one another preferred embodiment of the present invention; and

FIG. 8 is a flowchart illustrating the determination program of the memory according to the present invention.

### DETAILED DESCRIPTION OF THE PREFERRED EMBODIMENT

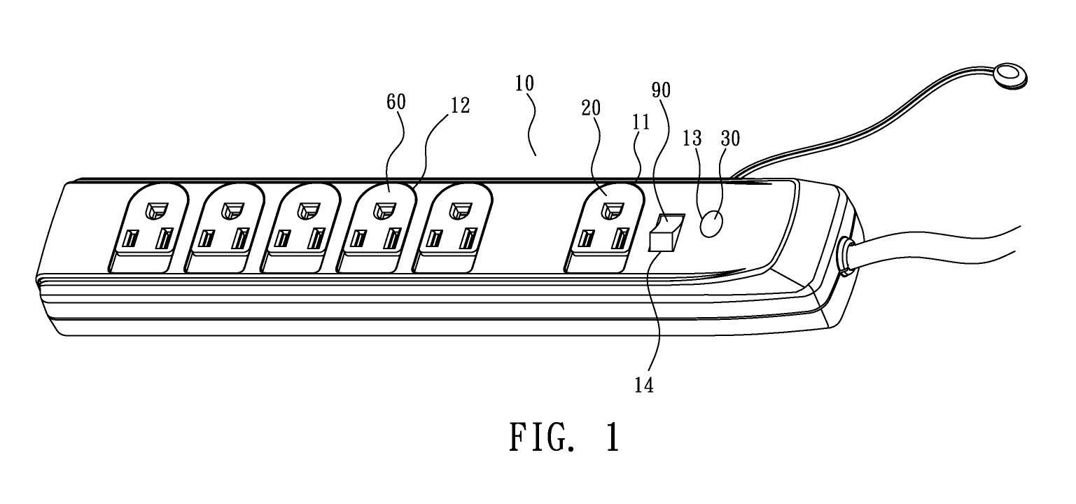

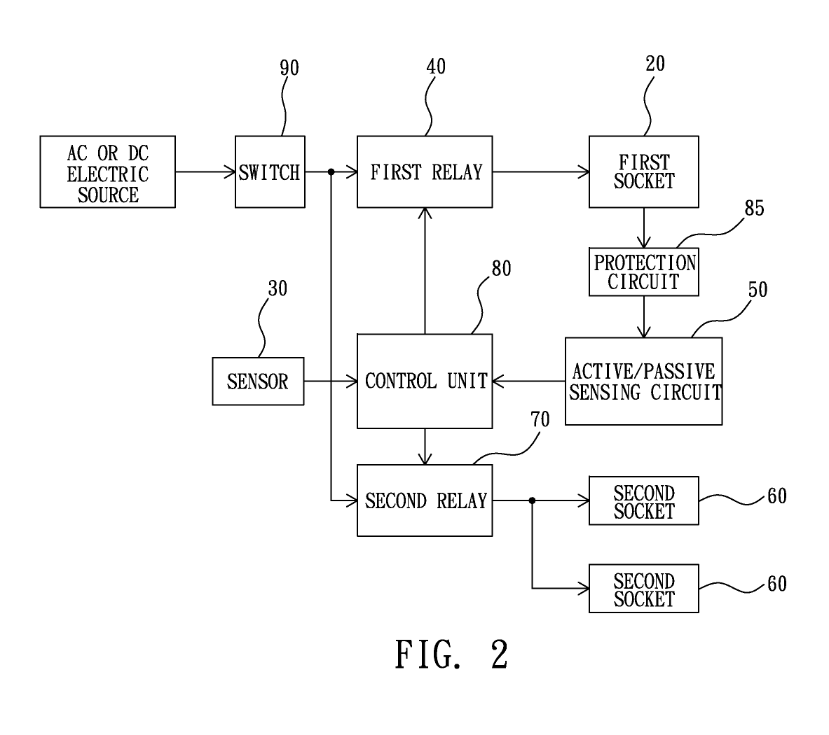

Referring to FIG. 1 and FIG. 2, wherein FIG. 1 is a schematic view showing the assembly of the dynamic energy-saving socket according to one preferred embodiment of the present invention; and FIG. 2 is a block diagram illustrating the dynamic energy-saving socket according of the present invention. According to the present invention, the dynamic energy-saving socket at least includes: a housing 10; a first socket 20; a sensor 30; a first relay 40; an active/passive sensing circuit 50; at least a second socket 60; a second relay 70; and a control unit 80.

The housing 10 is preferably made of an insulation material, e.g. but not limited to a plastic material, and is formed with a first orifice 11 and at least a second orifice 12 for accommodating the first socket 20, the sensor 30, the first relay 40, the active/passive sensing circuit 50, the second socket 60, the second relay 70 and the control unit 80.

The first socket 20 can be a conventional AC 110V two-hole or three-hole socket or a 220V three-hole socket, and be installed in the housing 10 but exposed outside the first orifice 11, thereby allowing an electric equipment (not shown in figures) to be inserted for obtaining the electric source required for operation. Wherein, the quantity of the first socket 20 is the same as that of the first orifice 11. According to one preferred embodiment of the present invention, the dynamic energy-saving socket respectively has a first socket 20 and a first orifice 11.

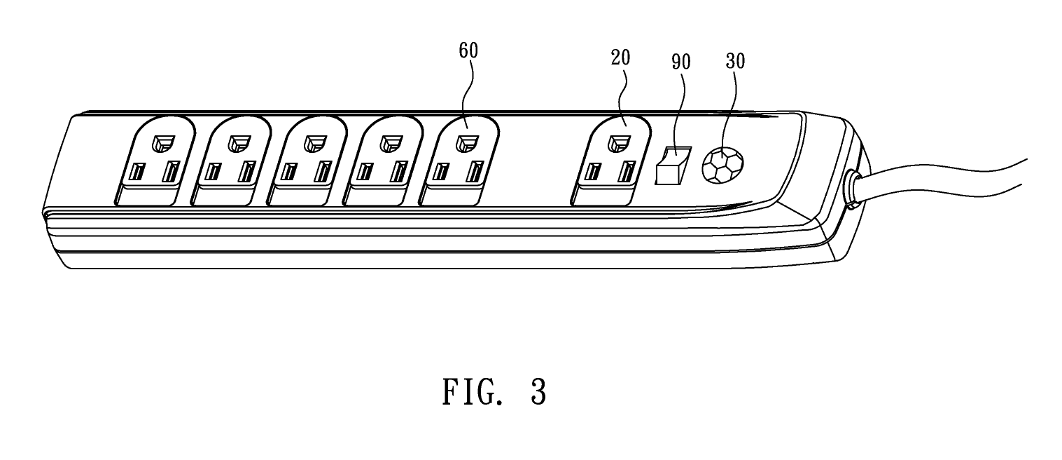

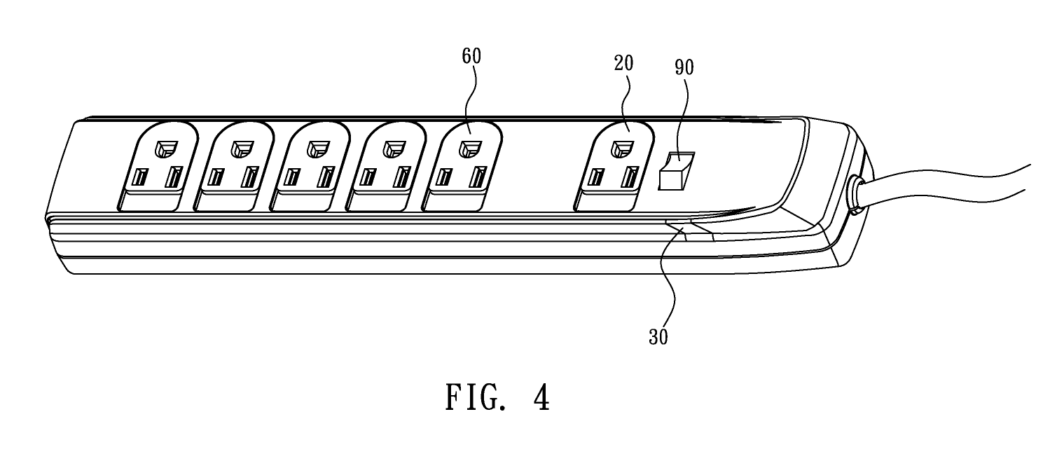

The sensor 30 is installed in the housing 10 or exposed outside the housing 10, and is used for sensing whether a human is approaching the first socket 20. Wherein, the sensor 30 can be an infrared (IR) sensor, a pyroelectric passive infrared (PIR) sensor or a radio frequency (RF) sensor, wherein the infrared (IR) sensor can be used for sensing any infrared turning-on or shutting-off signal emitted by a remote control (not shown in figures) of the electric equipment; the pyroelectric passive infrared (PIR) sensor can be used for sensing the human motion in front of the dynamic energy-saving socket; and the radio frequency (RF) sensor can be used for sensing any turning-on or shutting-off having a certain frequency emitted by the remote control of the electric equipment. According to the present invention, the sensor 30 adopted in the dynamic energy-saving socket is an infrared (IR) sensor, a pyroelectric passive infrared (PIR) sensor or a radio frequency (RF) sensor or a combination of the above three. For example, the embodiment disclosed in FIG. 1 adopts an infrared (IR) sensor as the sensor 30; the embodiment disclosed in FIG. 3 adopts a pyroelectric passive infrared (PIR) sensor as the sensor 30; the embodiment disclosed in FIG. 4 adopts a radio frequency (RF) sensor as the sensor 30. In addition, the adopted quantity of the sensor 30 is determined according to the actual needs, i.e. the dynamic energy-saving socket of the present invention can be installed with more than one of the infrared (IR) sensor, the pyroelectric passive infrared (PIR) sensor or the radio frequency (RF) sensor or a combination of the above three.

The first relay 40 is installed in the housing 10 and coupled to the first socket 20, one end thereof is coupled to an electric source, e.g. but not limited to an AC or DC electric source, and the first relay 40 is controlled by the control unit 80 for being conducted or terminated.

The active/passive sensing circuit 50 is installed in the housing 10 and coupled to the first socket 20 for sensing the loading value, e.g. but limited to the current value, applied to the first socket 20, wherein the active/passive sensing circuit 50 is, e.g. but not limited to, a current sensor capable of sensing the current of the first socket 20 and feeding back to the control unit 80.

The at least one second socket 60 is installed in the housing 10, and each second socket 60 is respectively exposed outside the second orifice 12 for allowing another electric equipment to be inserted; wherein, the quantity of the second socket 60 is the same as that of the second orifice 12. According to one preferred embodiment of the present invention, the dynamic energy-saving socket respectively has five second sockets 60 and six second orifices 12.

The second relay 70 is installed in the housing 10 and coupled to the second socket 60, one end thereof is coupled to the electric source, e.g. but not limited to an AC or DC electric source, and the second relay 70 is controlled by the control unit 80 for being conducted or terminated.

The control unit 80 is installed in the housing 10 and respectively coupled to the sensor 30, the first relay 40, the active/passive sensing circuit 50 and the second relay 70. The control unit 80 can be a microcontroller and further installed with a memory and an analogy-to-digital port (not shown in figures). When the sensor senses a human is approaching the first socket 20 or senses a turning-on or shutting-off signal emitted by a remote control (not show in figures), a sensing signal is outputted by the sensor to the analog-to-digital port of the control unit 80 for being converted into a digital data then transmitted to the control unit 80, then the control unit 80 outputs a first control signal to the first relay 40, such that the first relay 40 is conducted for supplying the electric source to the first socket 20; and when the active/passive sensing circuit 50 senses the loading value on the first socket 20 exceeding a threshold value, the control unit 80 outputs a second control signal to the second relay 70, such that the second relay 70 is conducted for supplying the electric source to the second socket 60. Accordingly, by utilizing the structure, the electric source of the second socket 60 can be terminated while the electric equipment is not turned on, thereby achieving the objective of saving energy.

After the dynamic energy-saving socket provided by the present invention is assembled, when the sensor 30 does not yet sense a human is approaching or a turning-on signal emitted by the remote control, the first relay 40 is still in a terminated state and no electric source is supplied to the first socket 20, as such, the standby current of the electric equipment is generated and wasted. When the sensor 30 senses a human is approaching the first socket 20 or the turning-on signal emitted by the remote control, the control unit 80 outputs the first control signal for controlling the first relay 40 for allowing the first relay 40 to be in a conducted state and the electric source is enabled to be supplied to the first socket 20 for allowing the electric equipment to be operated.

When the loading value of the first socket 20 exceeds a threshold value, wherein the threshold value can be any value according to actual needs and with respect to different products, the control unit 80 outputs a second control signal to the second relay 70, such that the second relay 70 is conducted for supplying the electric source to the second socket 60. As such, by utilizing the structure, the electric source supplied to the second socket 60 can be terminated when the loading value of the first socket 20 does not exceed a threshold value, and the electric equipment connected with the first socket 20 is enabled to be in a standby state, and the second socket 60 does not supply electric power, thereby avoiding the generation and consumption of standby current and effectively improving disadvantages of a conventional energy-saving socket.

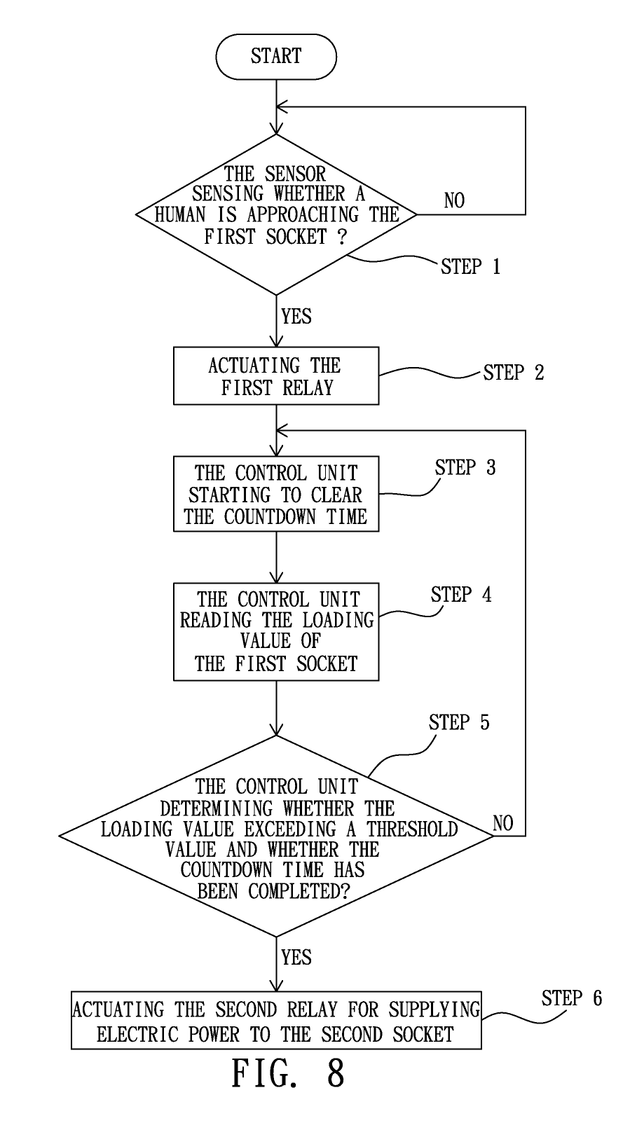

In addition, the memory of the control unit 80 further includes a determination program which is capable of determining whether the loading value of the electric equipment inserted with the first socket 20 exceeding the threshold value with respect to the total current fed by the active/passive sensing circuit 50, the determination principle and process is shown in FIG. 8.

Moreover, the dynamic energy-saving socket of the present invention further includes a protection circuit 85 which is installed in the housing 10 and coupled between the active/passive sensing circuit 50 and the first socket 20, when the current of the first socket 20 is overly high, a bypass function can be provided for protecting the dynamic energy-saving socket. The protection circuit 85 is a surge protection circuit or an EMI filter.

In addition, the dynamic energy-saving socket of the present invention further includes a switch 90 and the housing 10 further includes a third orifice 13 and a fourth orifice 14, wherein the third orifice 13 is provided for exposing the sensor 30, the switch 90 is installed in the housing 10 and exposed outside the fourth orifice 14, and the switch 90 is coupled between the electric source and the first relay 40 for turning on or shunting off the electric source.

Referring to FIG. 3, which is a schematic view showing the assembly of the dynamic energy-saving socket according to another preferred embodiment of the present invention. As shown in FIG. 3, the sensor 30 is a pyroelectric passive infrared (PIR) sensor capable of sensing the human motion in front of the first socket 20. Take the operation of controlling a television as an instance, when the user presses the turning-on button on a remote control for emitting a turning-on signal, the sensor 30 receives the turning-on signal emitted by the remote control, at this moment, the control unit 80 outputs a control signal for enabling the first relay 40 to be conducted, thereby supplying the electric source to the first socket 20 and enabling the television to be normally operated; if the sensor 30 senses a pyroelectric passive infrared signal within a certain period of time, e.g. 5 to 10 minutes, the sensed signal indicates that the user walks around instead of sitting or standing at a fixed location to watch television, so the control unit 80 determines that as a false action and re-terminates the electric source of the first socket 20, thereby avoiding the false action of the sensor 30.

Referring to FIG. 4, which is a schematic view showing the assembly of the dynamic energy-saving socket according to one another preferred embodiment of the present invention. As shown in FIG. 4, the sensor 30 is a radio frequency (RF) sensor, when the radio frequency (RF) sensor 30 receives a turning-on signal emitted by a radio frequency (RF) remote control, the control unit 80 outputs a control signal to control the first relay 40 thereby enabling the first relay 40 to be in a conducted state, at this moment, the electric source can be supplied to the first socket 20 for allowing the electric equipment to be normally operated. As such, with the dynamic energy-saving socket, the generation and consumption of standby current is prevented while the electric equipment being is a standby state, thereby effectively improving the disadvantages of the conventional socket.

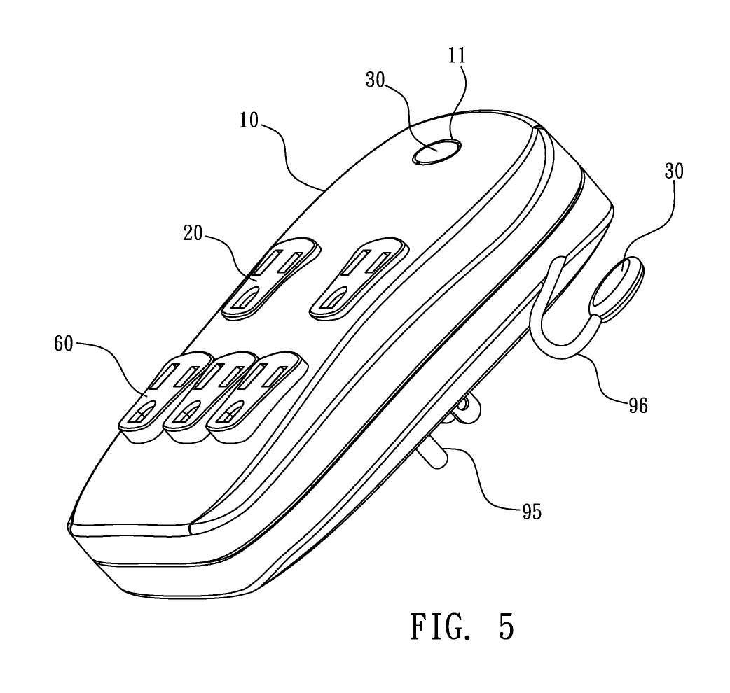

Referring to FIG. 5, which is a schematic view showing the assembly of the dynamic energy-saving socket according to still one another preferred embodiment of the present invention. As shown in FIG. 5, the dynamic energy-saving socket of the present invention can have its plug 95 to be disposed at the bottom of the housing 10, thereby reducing the volume of the dynamic energy-saving socket. Moreover, the infrared (IR) sensor 30 of the dynamic energy-saving socket can not only be installed in the housing 10 or be exposed outside the first orifice 11, but also capable of increasing its sensibility by utilizing a conduction cable 96 for extending to a certain length. Moreover, the dynamic energy-saving socket of the present invention can be installed with more than one sensor 30.

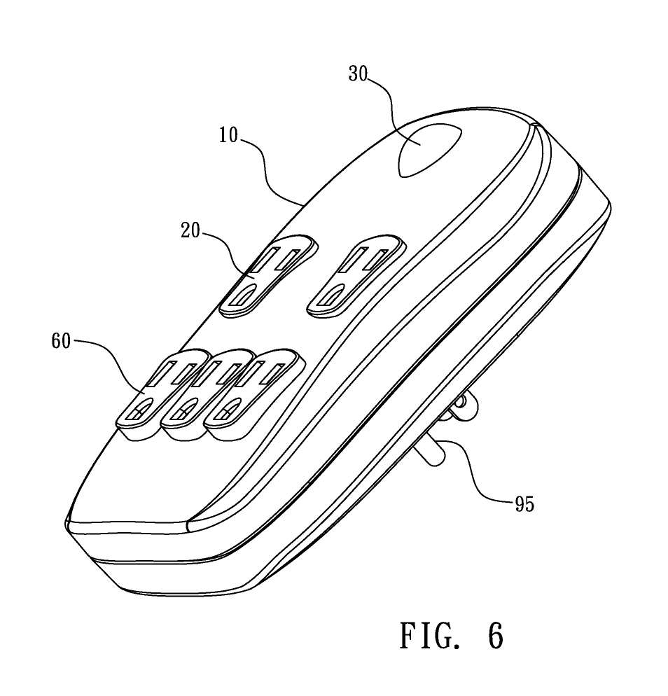

Referring to FIG. 6, which is a schematic view showing the assembly of the dynamic energy-saving socket according to still one another preferred embodiment of the present invention. As shown in FIG. 6, the plug 95 of the dynamic energy-saving socket can also be disposed at the bottom of the housing 10 for reducing the volume of the dynamic energy-saving socket; moreover, the infrared (IR) sensor 30 of the present invention is installed at the top of the housing 10 and exposed outside the first orifice 11 for increasing its sensibility.

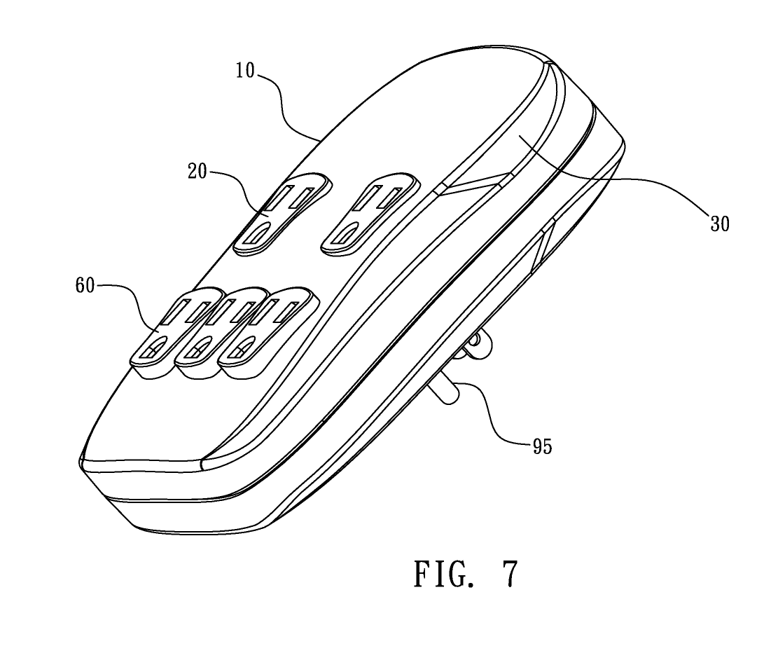

Referring to FIG. 7, which is a schematic view showing the assembly of the dynamic energy-saving socket according to still one another preferred embodiment of the present invention. As shown in FIG. 7, the plug 95 of the dynamic energy-saving socket can also be disposed at the bottom of the housing 10 for reducing the volume of the dynamic energy-saving socket; moreover, the infrared (IR) sensor 30 of the present invention is installed on a lateral lower side of the housing 10.

Referring to FIG. 8, which is a flowchart illustrating the determination program of the memory according to the present invention. As shown in FIG. 8, the control unit 80 of the dynamic energy-saving socket has a determination program, which comprises the steps of: the sensor 30 senses whether a human is approaching the first socket 20 (step 1); if YES, the first relay 40 is actuated (step 2); the control unit 80 starts to clear the countdown time (step 3); the control unit 80 reads the loading value of the first socket 20 (step 4); the control unit 80 determines whether the loading value exceeding a threshold value and whether the countdown time has been completed? (step 5); if YES, the second relay 70 is actuated for supplying electric power to the second socket 60 (step 6).

Wherein, in the step 1 and step 2, when the sensor 30 senses a human is approaching the first socket 20, the sensor 30 outputs a sensing signal to the analog-to-digital port of the control unit 80, then the control unit 80 outputs the first control signal to the first relay 40, thereby conducting the first relay 40 for allowing electric power to be supplied to the first socket 20. If the sensor 30 does not sense any human is approaching the first socket 20, then the sensing action continues.

In the step 3, the countdown time is e.g. but not limited to 3 minutes.

In the step 4, the loading value is fed by the active/passive sensing circuit 50 back to the analog-to-digital port of the control unit 80 for being converted to a digital data so as to be stored in the memory (not shown in figures).

In the step 5, if the control unit 80 determines the loading value has exceeded the threshold value, and the countdown time has been completed, the second control signal is outputted for conducting the second relay 70, thereby supplying electric power to the second socket 60. If the control unit 8 determines the loading value has not yet exceeded the threshold value, then back to the step 3; if the control unit 80 determines the loading value has exceeded the threshold value but the countdown time has not yet completed, then back to the step 4 to continuously reading the loading value and performing the countdown time till the loading vale exceeding the threshold value and the countdown being completed, then the control unit 80 outputs the second control signal for conducting the second relay 70, thereby supplying electric power to the second socket 60.

As what is disclosed above, the dynamic energy-saving socket provided by the present invention has a first socket and at least a second socket, when a human is approaching the sensor, the first relay is enabled to be conducted for supplying the electric source to the first socket, and when the loading value of the first socket exceeds a threshold value, the second relay is enabled to be conducted for supplying the electric source to the second socket, thereby achieving the objective of saving energy; and the present invention also has an advantage of determining whether the current of the socket exceeding a threshold value to decide supplying or not supplying electric power to the second socket of the dynamic energy-saving socket. As such, the dynamic energy-saving socket provided by the present invention is novel comparing to conventional sockets.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A dynamic energy-saving socket, comprising:
a housing formed with at least a first orifice and at least a second orifice;
a first socket installed in said housing and exposed outside said first orifice, and allowing an electric equipment to be inserted;
a sensor installed in said housing or exposed outside said housing, and capable of sensing whether a human is approaching said first socket;
a first relay installed in said housing and coupled to said first socket, one end thereof being coupled with an electric source, and capable of controlling whether supplying electric power to said first socket;
an active/passive sensing circuit installed in said housing and coupled to said first socket, capable of sensing the loading value of said first socket;
at least a second socket installed in said housing and each second socket being respectively exposed outside said second orifice for allowing another electric equipment to be inserted;
a second relay installed in said housing and coupled to said second socket, one end thereof being coupled to the electric source, and capable of controlling whether supplying electric power to said second socket; and
a control unit installed in said housing and respectively coupled to said sensor, said active/passive sensing circuit, said first relay and said second relay, when a human approaching said sensor, a first control signal being outputted to said first relay, so said first relay being conducted for supplying said electric source to said first socket, and when the loading value of said first socket exceeding a threshold value, a second control signal being outputted to said second relay, so said second relay is conducted for supplying said electric source to said second socket, thus said electric source of said second socket is enabled to be terminated when said electric equipment is not turned on, thereby achieving said objective of saving energy.

2. The dynamic energy-saving socket as claimed in claim 1, wherein said housing is made of an insulation material.

3. The dynamic energy-saving socket as claimed in claim 1, wherein the quantity of said second socket is the same as that of said second orifice.

4. The dynamic energy-saving socket as claimed in claim 1, wherein said sensor is an infrared (IR) sensor, a pyroelectric passive infrared (PIR) sensor, a radio frequency (RF) sensor or a combination thereof, wherein said infrared (IR) sensor is used for sensing any infrared turning-on or shutting-off signal emitted by a remote control of said electric equipment; said pyroelectric passive infrared (PIR) sensor is used for sensing the human motion; and said radio frequency (RF) sensor is used for sensing any turning-on or shutting-off signal having a certain frequency emitted by said remote control of said electric equipment.

5. The dynamic energy-saving socket as claimed in claim 1, wherein said control unit is a microcontroller and further installed with a memory and an analogy-to-digital port.

6. The dynamic energy-saving socket as claimed in claim 5, wherein said active/passive sensing circuit is a current sensor capable of sensing the current of said first socket and feeding back to said analog-to-digital port for being converted to a digital data then transmitted to said control unit.

7. The dynamic energy-saving socket as claimed in claim 6, wherein said memory further includes a determination program which is capable of determining whether the loading value of said electric equipment inserted with said first socket exceeding the threshold value with respect to the current fed by said current sensor.

8. The dynamic energy-saving socket as claimed in claim 1, further including a protection circuit installed in said housing and coupled between said active/passive sensing circuit and said first socket, when the current of said first socket is overly high, a bypass function is provided for protecting said dynamic energy-saving socket.

9. The dynamic energy-saving socket as claimed in claim 8, wherein said protection circuit is a surge protection circuit or an EMI filter.

10. The dynamic energy-saving socket as claimed in claim 1, further including a switch and said housing further includes a third orifice and a fourth orifice, wherein said third orifice is provided for exposing said sensor, said switch is installed in said housing and exposed outside said fourth orifice, and said switch is coupled between said electric source and said first relay for turning on or shunting off said electric source.
